(19) United States
(12) Patent Application Publication
(10) Pub. No.: US 2012/0207575 A1
(43) Pub. Date: Aug. 16, 2012

(54) DEVICE FOR TRANSFERRING PANEL MATERIAL IN A PRODUCTION LINE AND PRODUCTION LINE FOR PANEL MATERIAL

(75) Inventors: Alberto Masoero, Cuneo (IT); Andreas Würth, Rain (DE); Thomas Pfeilschifter, Kaisheim (DE); Thomas Schretzmeir, Lauterbach (DE)

(73) Assignees: BOTTERO S.P.A., Cuneo (IT); BOTTERO GMBH, Donauwörth (DE)

(21) Appl. No.: 13/389,342

(22) PCT Filed: Aug. 4, 2010
(86) PCT No.: PCT/EP2010/061377

§ 371 Date: Apr. 23, 2012

(30) Foreign Application Priority Data
Aug. 7, 2009 (DE) 10 2009 036 700.4

(51) Int. Cl. B25J 15/00

(52) U.S. Cl. 414/751.1

(57) ABSTRACT

The invention relates to a device for transferring panel material in a production line, particularly for producing glass panels, solar cells, or flat glass, but also sheet metal parts or panel materials for producing furniture, plastic panels, etc. The device comprises a first arm (1) that can be driven about a first rotary axis (1A), at least one second arm (2) that can be driven about a second rotary axis (2A) mounted on the first arm (1), wherein the second rotary axis (2A) is parallel to the first rotary axis (1A), and a manipulation device (3) disposed on at least the second arm (2) that can selectively grip and release the panel material. The motion of the first arm (1) around the first rotary axis (1A) and the motion of the second arm (2) around the second rotary axis (2A) are or can be controlled so that the manipulation device (3) pivot's below a defined region of the panel material to be transferred in the transfer position, and is positioned from the bottom on the panel material in the transfer position. The panel material can thereby be continuously or nearly continuously fed to the transfer position and the cycle time of a transfer cycle can be reduced.

The present invention relates to a device for transferring panel material in a production line, in particular for producing glass panels, solar cells, or flat glass, but also sheet metal parts or panel materials for producing furniture, plastic panels, etc. The invention relates further to a production line for such panel material.

The transfer of panel material in a production line may take place at different stations of a production process, in particular when stacking the panel material fed to a horizontal conveyance system in an essentially vertical or slightly inclined stacking position on a pallet or a plate carrier for further transport, in the case of transfer in the opposite direction from a transport device, from an essentially vertical or diagonal stacking position to a horizontal conveyance system or when restacking from a stacking position or stacking device or production station to a different one.

A device for transferring panel material having the functionality of plate transfer from a plate conveyor to a stacking rack is known for example from EP 1493695 A1. In the case of this device for panel transfer, a panel gripper, in particular a suction frame, can be swiveled on a free end of a transport arm, which is disposed on a frame that can be swiveled around an axis.

The swivel motion of the transport arm is kinematically coupled with the swivel motion of the panel gripper via two rods. The arrangement is such that the transfer of a panel material by alternating swivel motions of the transport arm takes place in alternating directions.

A device for transferring panel material from a panel conveyor to a stacking rack is known from EP 1298080 A1, which has a swiveling, bent arm alternating around a first axis in every transfer cycle, which arm bears a suction frame that can be swiveled around a second axis on its free end. The first and second axes are parallel to each other. A panel conveyor for feeding the panel material to a transfer position is provided with recesses in the region of the arm in order to make it possible for the arm and the suction frame to dip from the upper side. Feeding the panel material into the transfer position may therefore not take place until the arm and suction frame are situated beneath the transfer position.

A device for transferring plate-shaped objects from a horizontal conveyance system to a vertical stacking rack is known from DE 4211317 A1, in which two swivel arms, which can be driven in a parallel manner and are provided with a manipulation device, are provided, which can be moved back and forth between an essentially vertical end position and an essentially horizontal end position by swiveling 90 to 100°. The movement of each of the swivel arms is realized by two crank mechanisms, wherein the crank mechanisms each have a crank, which is moved via a drive motor. The free end of the one crank is connected to a coupling rod via a swivel joint, which is connected in turn to the swivel arm via another swivel joint. The free end of the other crank is connected directly to the swivel arm via a swivel joint.

In the case of known devices, it is necessary to delay the feeding of the panel materials by a horizontal conveyance system to the transfer position until the manipulation device has been moved into the transfer position so that its movement is not hindered by the panel material. In addition, the manipulation device that was moved into the transfer position must then wait until the conveyance system starts up again and the to-be-transferred piece of panel material has been transported to the transfer position before the piece of panel material may be gripped and the transfer may be carried out.

A device for stacking and unstacking plate-shaped goods is known from DE 3928850 A1, which has two lateral lever systems and a frame, which has a number of suction grippers and can be swiveled with the aid of the lever system out of a horizontal position, in which the suction grippers are gripping the plate-shaped goods into an essentially vertical position. The lateral lever systems are designed as articulated arms each made of a swivel arm and a manipulation arm, wherein a swivel joint is configured between the swivel arm and the base, a manipulation joint between the swivel arm and the manipulation arm, and a frame joint between the manipulation arm and the frame, in each case as active joints. The swivel arm and the manipulation arm move during a transfer cycle respectively in a reversing manner.

A stacking device for glass panels is known from U.S. Pat. No. 5,620,293 A, which has a pair of L-shaped lever arms disposed in a parallel manner, said arms being articulated on a lower end on a base so they can swivel and on a roller frame on an upper end. The lever arms and thus the roller frame are swiveled in a reversing manner on a circular arc between a horizontal position and an essentially vertical position by means of a hydraulic cylinder engaging on the lever arms, the hydraulic cylinder being disposed in a recessed manner in the base beneath the device.

Finally, a device for transferring smaller plate-like workpieces is known from EP 0435417 A1, which is disposed between two tables arranged side by side on which the transfer positions for the workpieces are located. The device has a first longer arm, which can be moved back and forth in pendulum fashion around a first axis, and a second shorter arm disposed on the free end of the first arm, which can be moved in pendulum fashion around a second axis that is parallel to the first axis. The arrangement and length of the arms is selected such that the workpieces are always gripped from the upper side.

The object of the invention is providing an improved device for transferring panel material in a production line that eliminates at least some of the cited disadvantages. The invention is also supposed make a production line having such an improved transfer device available.

A device for transferring panel material in a production line according to Claim 1 and a production line according to Claim 10 are proposed according to the invention to attain this object. Preferred embodiments are disclosed in the dependent claims.

Thus, the device according to the invention for transferring panel material in a production line comprises a first arm that can be driven around a first rotary axis, at least one second arm that can be driven around a second rotary axis mounted on the first arm, wherein the second rotary axis the second rotary axis is parallel to the first rotary axis, and a manipulation device for the panel material to be transferred, said manipulating device being disposed on the at least one second arm that can selectively grip and release the panel material.

The motion of the first arm around the first rotary axis and the motion of the second arm around the second rotary axis are or can be controlled so that, in the event of a movement to a transfer position, the manipulation device pivots in beneath a region, which is defined by the panel material that is to be transferred, in the transfer position, and is positioned on the panel material from the underside in the transfer position.

The device according to the invention will be explained in greater detail in the following on the basis of the enclosed drawings, which show the following:

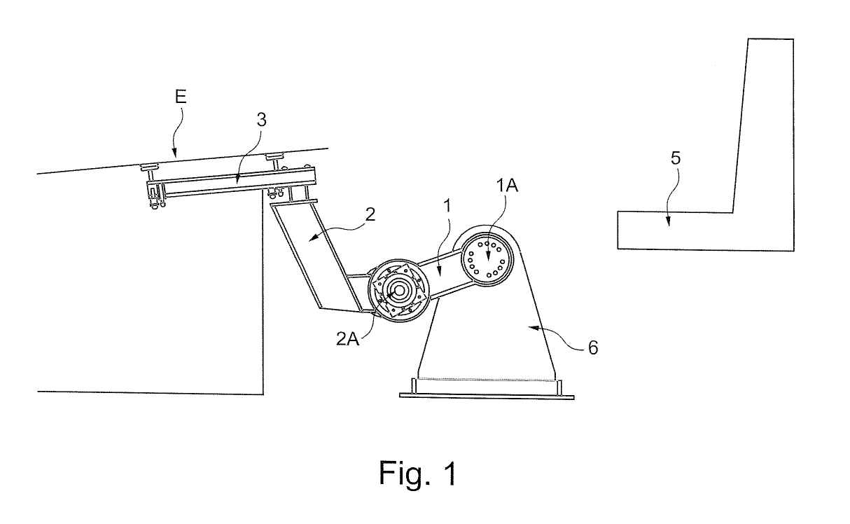

FIG. 1 A lateral view of a device according to a first embodiment to explain the essential elements;

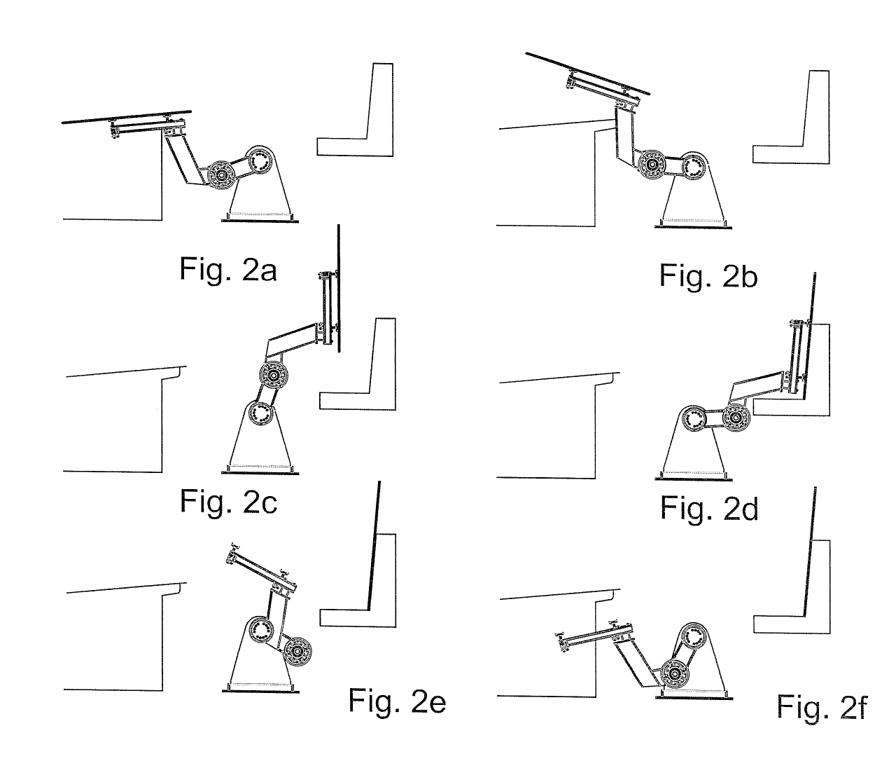

FIGS. 2a to 2f A schematic representation of characteristic positions of the sequence of motion of the device from FIG. 1 in a first variant when transferring a panel material from a transport device to a stacking rack;

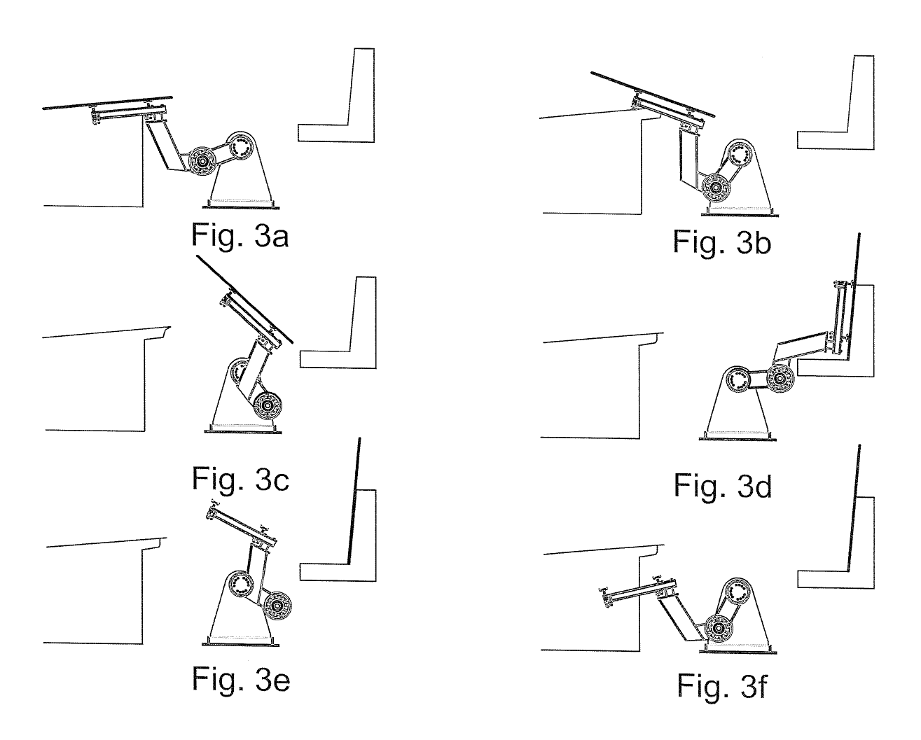

FIGS. 3a to 3f A schematic representation of characteristic positions of the sequence of motion of the device from FIG. 1 in a second variant when transferring a panel material from a transport device to a stacking rack;

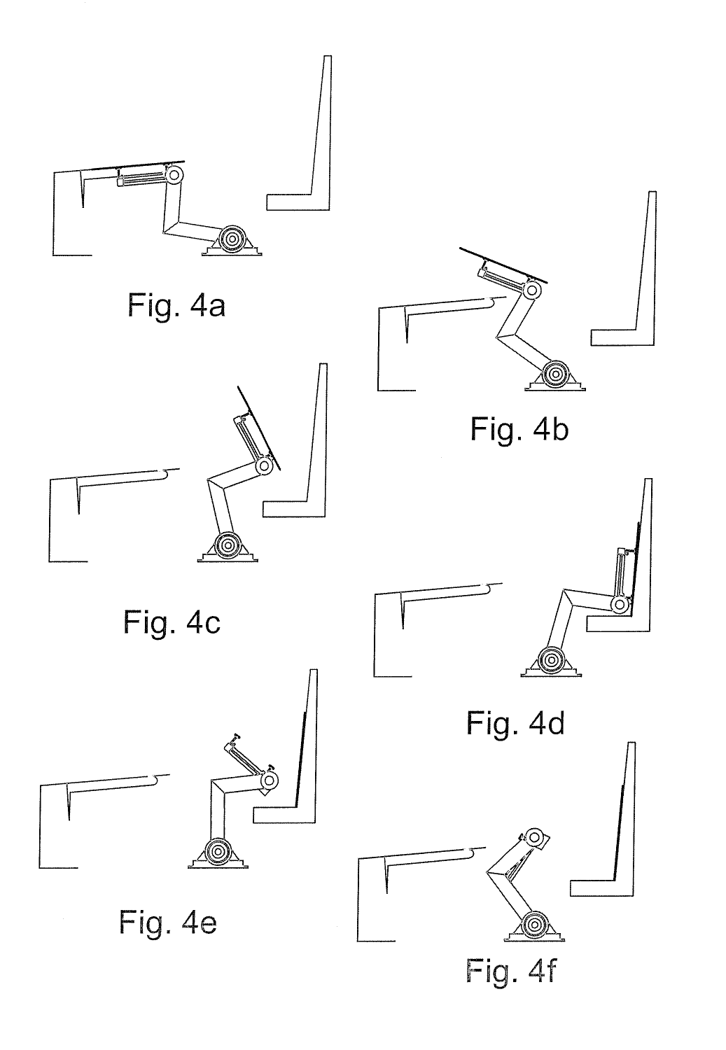

FIGS. 4a to 4f A schematic representation of characteristic positions of the sequence of motion of a device according to a second embodiment when transferring a panel material from a transport device to a stacking rack; and

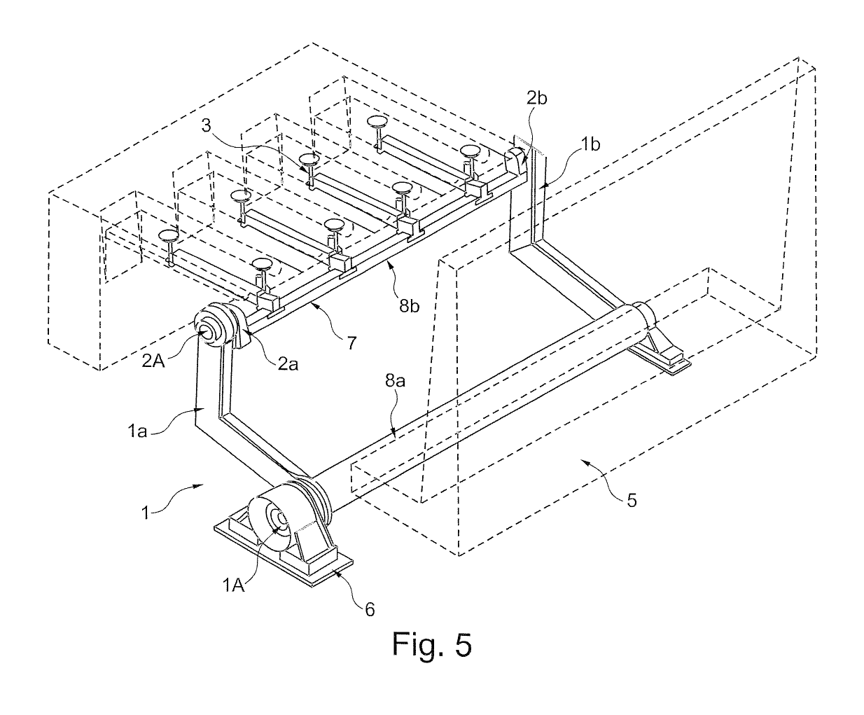

FIG. 5 A perspective representation of the device from FIG. 4.

The device according to the invention in accordance with the first embodiment depicted in FIG. 1 includes a first arm 1, which can be driven around a first rotary axis 1A on an end of the first arm, and a second arm 2, which can be rotated around a second rotary axis 2A that is swivel-mounted on the first arm 1.

The second rotary axis 2A is located on the other end of the first arm and the second rotary axis 2A is parallel to the first rotary axis 1A. The first arm is positioned on a base 6 at a height above a floor surface which is higher than the length of the first arm 1. The first and second rotary axes are parallel to the floor surface.

Disposed on the free end of the second arm 2 is a manipulation device 3 for the panel material to be manipulated. The manipulation device 3 may be designed in the form of a plate gripper known from the prior art, for example in the form of a suction frame with corresponding gripping devices for the panel material, in order to selectively grip and release said panel material. The manipulation device 3 may be disposed in a fixed position on the end of the second arm or be movable relative to the second arm via a third axis or a plurality of third axes.

The transfer of the panel material, for example glass panels, flat glass, plastic panels, solar cells, sheet metal and the like, normally takes place from a horizontal conveyance system or one that is inclined if need [be] up to approx. 30° from the horizontal, onto which the panel material is sequentially fed continuously or discontinuously. The conveyance system defines a transport plane E. The transfer of the panel material is carried out by the device according to the invention from the location in a transfer position in the transport plane E to an essentially vertical or slightly diagonally inclined stacked position in another transfer position on a stacking rack 5 or a pallet. The transfer may also take place at a further processing station of the production line or in the opposite direction.

The first rotary axis 1A and the second rotary axis 2A are each allocated their own drive device with a gear mechanism and motor, preferably an electric motor that can be regulated and controlled (a servomotor, for example) in order to effectuate the rotation around the respective rotary axis.

The direction of rotation of the first arm around the first rotary axis 1A when considered over the entire transfer cycle, i.e., from a first transfer or pick-up position to a second transfer or deposit position and back again to the first transfer position, is respectively opposite from the direction of rotation of the second arm around the second rotary axis 2A, wherein the directions of rotation for a transfer of the panel material in the opposite direction may be respectively reversed. However, the direction of rotation of both rotary axes may be in the same direction for a short time in order to achieve in particular a desired positioning of the manipulation device in the final positions.

In a preferred variant of the first embodiment, the rotation of the first arm and of the second arm during the transfer process is respectively unidirectional in one direction (continuous) and takes place over a range of approx. 360° during every transfer cycle. A transfer cycle is understood in this case to be a movement of the manipulation device from a pick-up position to a deposit position and back into the pick-up position. The advantage of the continuous or unidirectional movement of the two rotary axes is that a high transfer frequency may be achieved. Though the movement at the pick-up and deposit positions is briefly stopped or decelerated if need be in order to allow time for gripping or releasing and depositing the panel material, the continuation of the movement in the same direction is kinematically advantageous (also see the sequence of motion depicted in FIGS. 2a to 2f).

The arrangement of the first and of the second arm with respect to the length, shape and arrangement in the device and control of the rotation of the first arm around the first rotary axis and of the second arm around the second rotary axis are selected in such a way that, in the event of a movement to the pick-up or transfer position, as shown in FIGS. 2a to 2f, the manipulation device pivots in beneath the horizontal transport plane and specifically beneath a region defined and occupied by the panel material that is to be transferred (and if applicable the conveyance system) in the transfer position, and approaches from a position beneath the transport plane of the underside of the panel material situated in the transfer position and is correspondingly positioned in the transfer position. As a result, the panel material is able to be gripped by the manipulation device on the underside, i.e., in the case of flat glass on the so-called bath side or tin side, and, during the return movement to the pick-up or the first transfer position, the manipulation device or the second arm does not move from above through the region defined and occupied by the panel material to be transferred (and if applicable the conveyance system) to the transfer position.

In the case of the variant of the first embodiment depicted in FIGS. 2a-2f, the first arm is situated in the gripping position in a range between 6:00 and 9:00 o'clock (as related to a time division of 12 hours) (see FIGS. 2f and 2a). Furthermore, in the case of the first embodiment, the first arm is dimensioned and arranged in such a way that, during the entire rotational movement around the first rotary axis, it is situated essentially beneath the horizontal transport plane of the panel material fed to the transfer device. However, this is not absolutely necessary—the design of the first and the second arms may in fact [be] a function of the specific spatial conditions at the transfer position such as the height level of the pick-up and transfer position and any possible projecting edges in the path of motion of the arms and the manipulation device.

In order to facilitate the movement of the first arm, the first rotary axis is arranged, as shown, on a base above the floor, which is higher than the length of the first arm.

Alternatively, a recess may also be provided in the floor in order to provide the required clearance for the movement of the first arm in the region of the bottom dead center.

Offered as drive devices for the rotary axes are those having an electric motor and gear mechanism that can be regulated and controlled, for example a servomotor, which are also used in the field of robotics drives, because they can be actuated directly and precisely controlled. In the case of the device according to the invention, the drive devices of the two rotary axes can be controlled independently of one another.

The movement trajectory of the manipulation device of the device according to the invention can be seen from the sequence of positions in FIGS. 2a to 2f. So that the second arm does not collide with the stacking rack in the area approaching the transfer/delivery position at the stacking rack, said arm is preferably designed to be curved or angular so that it is able to pass by any rack parts that may be projecting into the rotation area. The embodiment depends upon the spatial situation at the respective use position. The first arm may likewise be designed to be curved or angular.

The device according to the invention permits a continuous transfer of the panel material at a high speed or frequency and with short cycle times without the direction of movement of the arms between the individual transfer cycles having to be reversed. By synchronizing the conveyance speed of the panel material to the transfer position on the conveyance system with the rotation speed of the transfer device, a nearly continuous transfer process with a constant high frequency is able to be achieved.

Because the manipulation device pivots in during the return movement on the trajectory beneath the transport plane or the region which is defined by the panel material in the transfer position without crossing through said region from the upper side, transport of the panel material is not interrupted in the transfer position, but may take place at the same time as the pivoting-in process. As a result, the cycle time may be further reduced considerably by avoiding waiting times, because the next panel material part to be transferred on the conveyance system does not have to wait in the pick-up position for the manipulation device to pivot in. The time gained or the shortened cycle is achieved as compared to the prior art in particular in that the next panel material part to be transferred does not have to stop in front of the pick-up position, because the manipulation device is able to be positioned in the pick-up position from the underside of the transport plane without being hindered by the panel material part, and secondly the acceleration process of the panel material part out of the waiting position into the pick-up position may be eliminated. This acceleration process is limited in terms of its dynamics in that the panel material is only held on the conveyance system by the force of gravity and the acceleration is therefore limited by the frictional forces.

Limiting the transfer device to the two or three parallel main rotary axes (first and second rotary axes 1A, 2A) makes it possible for the high cycle frequency to be achieved as compared to standard multi-axle industrial robots.

In a further variant of the first embodiment, the kinematics of the arms may be modified to the effect that the rotation of the first arm and of the second arm around the first or second rotary axis is not continuous (as described above) in the case of successive transfer cycles, but takes place in a reversing or alternating manner with every transfer cycle.

The first axis then executes a reciprocating motion in an angular region around the bottom dead center, while the second axis likewise executes an alternatingly or reciprocating swivel motion in the respective opposite direction in an angular region around the top dead center. In the case of this variant as well, the movement trajectory of the manipulation device is selected in such a way that, during the return movement to the transfer/pick-up position, said manipulation device pivots in beneath the transport plane of the panel material or the region defined by the panel material in the transfer position without crossing through said region from the upper side.

The reciprocating motion of the first axis in an angular region around the bottom dead center is kinematically and energetically advantageous, because the force of gravity supports the acceleration and the deceleration in the end positions when changing directions. The structural arrangement of the device may correspond to that of the first variant, wherein merely the drive devices are actuated in a different manner. The movement trajectory of the manipulation device of the device according to the invention for this variant can be seen from the sequence of positions in FIGS. 3a to 3f.

The device according to the invention was described in the foregoing specifically on the basis of a device having two individual arms as a so-called mono-arm device. However, it is also possible to design the first and the second arms, retaining the kinematics and other structure, incidentally in the form of two or more parallel arm parts that are connected rigidly to one another via a cross member.

Moreover, the manipulation device may be provided not only on the second arm, but on a further arm connected to the second arm so it can move around a third rotary axis.

FIGS. 4a-4f and 5 depict a second embodiment of the invention, which differs from the first embodiment in that the first arm is designed to be longer and angled, while the second arm is designed to be clearly shorter and is formed by the distance between the second rotational axis and a frame 7, which bears the manipulation device in the form of a gripper frame. The second embodiment is designed as double-arm device, in which the first and the second arms are formed by a pair of arm parts 1a, 1b or 2a, 2b, which are disposed in a parallel manner and connected rigidly to one another via a cross member 8a or 8b so that they move synchronously. Due to the fact that the first arm is mounted at a position on the base relatively near to the floor surface, it is not able to move continuously around the first rotary axis, but only reversing in a reciprocating motion. Different than with the second variant of the first embodiment, the reciprocating or swivel motion takes place in this case upwardly in an angular region around the top dead center.

In the case of this embodiment as well, the movement of the second arm around the second rotary axis is also a reversing movement, which is in the same direction of the movement of the first arm around the first rotary axis and is controlled in such a way that, in the case of the return movement to the transfer/pick-up position, the manipulation device pivots in beneath the transport plane of the panel material or the region defined by the panel material in the transfer position without crossing though said region from the upper side, and is positioned on the panel material from the underside in the transfer position. This embodiment is advantageous, because even large panel material pieces may be transferred with shortened cycle times on the reciprocating and dipping path of motion created by the first and second axes. The movement trajectory of the manipulation device of the device according to the invention for this second embodiment can be seen from the sequence of positions in FIGS. 4a to 4f.

Although the second embodiment was described as a double-arm device, it may also be designed like the first embodiment as a mono-device.

According to the foregoing description, the invention also relates to a production line for producing panel materials, in particular glass panels, glass panes, or flat glass, which provides a conveyance system for sequentially feeding the panel material to a transfer position, and a device for transferring panel material according to the described embodiments. The device for transferring panel material is respectively disposed such that it may grip the panel material as described at the transfer position on the underside and transfer it to a further transfer position. Due to the fact that, during the return movement to the transfer position, the manipulation device or the second part pivots in beneath the region defined by the panel material to be transferred in the transfer position without crossing through said region from the upper side, the conveyance system is able to feed the panel material to the transfer position continuously or nearly continuously or with only a short delay.

1. Device for transferring panel material in a production line comprising
a first arm (1) that can be driven around a first rotary axis (1A),
at least one second arm (2) that can be driven around a second rotary axis (2A) mounted on the first arm (1), wherein the second rotary axis (2A) is parallel to the first rotary axis (1A), and
a manipulation device (3) for the panel material to be transferred, which manipulation device is disposed on at least the second arm (2) that can selectively grip and release the panel material,
wherein the motion of the first arm (1) around the first rotary axis (1A) and the motion of the second arm (2) around the second rotary axis (2A) are or can be controlled so that, in the event of a movement to a transfer position, the manipulation device (3) pivots in beneath a region, which is defined by the panel material that is to be transferred, in the transfer position, and is positioned on the panel material from the underside in the transfer position.

2. The device for transferring panel material according to claim 1, wherein the first rotary axis (1A) and the second rotary axis (2A) are each allocated a drive device having a motor, preferably an electric motor that can be regulated and controlled.

3. The device for transferring panel material according to claim 2, wherein the directions of rotation of the first arm (1) and of the second arm (2) around the first or second rotary axis (1A, 2A) are opposed to one another during a transfer cycle.

4. The device for transferring panel material according to claim 2, wherein the directions of rotation of the first arm (1) and of the second arm (2) around the first or second rotary axis (1A, 2A) are in the same direction during a transfer cycle.

5. The device for transferring panel material according to claim 4, wherein the first and/or the second arm (1, 2) is/are curved.

6. The device for transferring panel material according to claim 5, wherein the first arm (1) and the second arm (2) each includes at least two arm parts (1a, 1b, 2a, 2b) disposed in a parallel manner and connected rigidly to one another via a cross member.

7. The device for transferring panel material according to claim 6, wherein the rotation of the first arm (1) and of the second arm (2) around the first or second rotary axis (1A, 2A) reverses with every transfer cycle.

8. The device for transferring panel material according to claim 6, wherein the rotation of the first arm (1) and/or of the second arm (2) around the first or second rotary axis (1A, 2A) is continuous or unidirectional in the case of successive transfer cycles.

9. The device for transferring panel material according to claim 7, wherein the first arm (1) executes a reciprocating motion in an angular region around the top or bottom dead center.

10. Production line for producing panel materials, in particular glass panels, glass panes, or flat glass, comprising
a conveyance system for sequentially feeding the panel material to a transfer position, and
a device for transferring panel material according to claim 1, which is disposed such that it may grip the panel material at the transfer position on the underside and transfer it to a further transfer position.

11. Production line according to claim 10, wherein the conveyance system feeds the panel material continuously or nearly continuously to the transfer position.

12. Device for transferring panel material in a production line comprising
a first arm (1) that can be driven around a first rotary axis (1A),
at least one second arm (2) that can be driven around a second rotary axis (2A) mounted on the first arm (1), wherein the second rotary axis (2A) is parallel to the first rotary axis (1A), and
a manipulation device (3) for the panel material to be transferred, which manipulation device is disposed on at least the second arm (2) that can selectively grip and release the panel material,
wherein the motion of the first arm (1) around the first rotary axis (1A) and the motion of the second arm (2) around the second rotary axis (2A) are or can be controlled so that, in the event of a movement to a transfer position, the manipulation device (3) pivots in beneath a region, which is defined by the panel material that is to be transferred, in the transfer position, and is positioned on the panel material from the underside in the transfer position, such that the directions of rotation of the first arm (1) and of the second arm (2) around the first or second rotary axis (1A, 2A) are opposed to one another during a transfer cycle.

13. The device for transferring panel material according to claim 12, wherein the directions of rotation of the first arm (1) and of the second arm (2) around the first or second rotary axis (1A, 2A) are in the same direction during a transfer cycle.

14. The device for transferring panel material according to claim 12, wherein the first and/or the second arm (1, 2) is/are curved.

15. The device for transferring panel material according to claim 12, wherein the first arm (1) and the second arm (2) each includes at least two arm parts (1a, 1b, 2a, 2b) disposed in a parallel manner and connected rigidly to one another via a cross member.

16. The device for transferring panel material according to claim 12, wherein the rotation of the first arm (1) and of the second arm (2) around the first or second rotary axis (1A, 2A) reverses with every transfer cycle.

17. The device for transferring panel material according to claim 12, wherein the rotation of the first arm (1) and/or of the second arm (2) around the first or second rotary axis (1A, 2A) is continuous or unidirectional in the case of successive transfer cycles.

18. Production line for producing panel materials, in particular glass panels, glass panes, or flat glass, comprising
a conveyance system for sequentially feeding the panel material to a transfer position, and
a device for transferring panel material according to claim 17, which is disposed such that it may grip the panel material at the transfer position on the underside and transfer it to a further transfer position.

19. Production line according to claim 19, wherein the conveyance system feeds the panel material continuously or nearly continuously to the transfer position.

20. Device for transferring panel material in a production line comprising
a first arm (1) that can be driven around a first rotary axis (1A),
at least one second arm (2) that can be driven around a second rotary axis (2A) mounted on the first arm (1), wherein the second rotary axis (2A) is parallel to the first rotary axis (1A),
a manipulation device (3) for the panel material to be transferred, which manipulation device is disposed on at least the second arm (2) that can selectively grip and release the panel material,
wherein the motion of the first arm (1) around the first rotary axis (1A) and the motion of the second arm (2) around the second rotary axis (2A) are or can be controlled so that, in the event of a movement to a transfer position, the manipulation device (3) pivots in beneath a region, which is defined by the panel material that is to be transferred, in the transfer position, and is positioned on the panel material from the underside in the transfer position,
further wherein the first arm (1) and the second arm (2) each includes at least two arm parts (1a, 1b, 2a, 2b) disposed in a parallel manner and connected rigidly to one another via a cross member.
